(19) United States
(12) Patent Application Publication
(10) Pub. No.: US 2008/0046820 A1
(43) Pub. Date: Feb. 21, 2008

(54) APPARATUS AND METHOD FOR CONTROLLING MEDIA PLAYER IN PORTABLE TERMINAL

(75) Inventors: Hee-Young Lee, Yongin-si (KR); Chul-Hwan Lee, Seoul (KR); Jin-Woo Jung, Suwon-si (KR); Hyun-Young Mo, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS., LTD., Suwon-si (KR)

(21) Appl. No.: 11/840,798

(22) Filed: Aug. 17, 2007

(30) Foreign Application Priority Data
Aug. 18, 2006 (KR) 2006-0077974

(51) Int. Cl. G06F 3/048

(52) U.S. Cl. 715/716

(57) ABSTRACT

Provided are an apparatus and method for controlling a media player running on a background in a portable terminal. In the apparatus, an input unit includes a plurality of keys, and a control unit sets a key for controlling the media player running on the background using one or more keys of the input unit.

### PRIORITY

This application claims priority under 35 U.S.C. §119 to an application filed in the Korean Intellectual Property Office on Aug. 18, 2006 and assigned Serial No. 2006-77974, the contents of which are incorporated herein by reference.

### BACKGROUND OF THE INVENTION

1. Field of the Invention

The present invention relates generally to a portable terminal capable of playing media files, and in particular, to an apparatus and method for controlling a media player running on a background.

2. Description of the Related Art

In recent years, portable terminals have become indispensable items for modern consumers, and service providers and terminal manufacturers are competitively developing portable terminals and services in order to have an advantage over other manufacturers.

The portable terminals can provide a variety of additional functions and services, such as a phone book function, a game function, a short message service, a scheduler function, an e-mail service, a morning call or wake-up function, a digital camera function, a wireless Internet service, and so on.

With the development of digital multimedia technology, portable terminals that can play music files have been developed and are available in the market. That is, users can listen to the music using the portable terminals, without MPEG Layer 3 (MP3) players or portable cassette players. Accordingly, the use of portable terminals is increasing because of their convenience.

The portable terminal provides a multi-tasking function that can perform other applications while playing music files. For example, while playing music files, the portable terminal can perform the game function, the phone book function, the short message service, the scheduler function, and so on.

However, the portable terminal must stop or pause the running applications in order to control the operation of the media player.

That is, the portable terminal needs to perform a plurality of procedures for pausing or stopping the running applications in order to play media files.

Therefore, what is required is an apparatus and method that can control the play and stop operations of the media player independently of the operations of the applications running on the portable terminal.

### SUMMARY OF THE INVENTION

An object of the present invention is to substantially solve at least the above problems and/or disadvantages and to provide at least the advantages below. Accordingly, an object of the present invention is to provide an apparatus and method for controlling a media player running on a background in a portable terminal.

Another object of the present invention is to provide an apparatus and method for setting a key for controlling a media player running on a background in a portable terminal.

A further object of the present invention is to provide an apparatus and method for controlling a pause or stop operation of a media player that is playing a media file on a background in a portable terminal.

A still object of the present invention is to provide an apparatus and method for controlling a play operation of a media player running on a background in a portable terminal.

According to one aspect of the present invention, an apparatus for setting a key for controlling a media player running on a background in a portable terminal includes an input unit including a plurality of keys; and a control unit for setting a key for controlling the media player running on the background using one or more keys of the input unit.

According to another aspect of the present invention, an apparatus for controlling a media player running on a background in a portable terminal includes an input unit including a key for controlling the media player; a media management unit for controlling an operation of the media player running on the background; and a control unit for controlling the media management unit to control the operation of the media player when the control unit detects an input of the key for controlling the media player.

According to a further aspect of the present invention, a method for setting a key for controlling a media player running on a background in a portable terminal includes displaying a key setup screen when a request for setting a key for controlling the media player is detected; and detecting a key input and registering the key for controlling the media player.

According to a still aspect of the present invention, a method for controlling a media player running on a background in a portable terminal includes detecting a key input after the media player is run on a background; determining a current state of the media player when the detected key input is a key input for controlling the media player; and stopping an operation of the running media player when it is determined that the media player is playing media files.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of an apparatus for controlling a media player running on a background in a portable terminal according to the present invention;

FIG. 2 is a flowchart illustrating a method for setting a key for controlling a media player running on a background in a portable terminal, according to the present invention; and

FIG. 3 is a flowchart illustrating a method for controlling a media player running on a background in a portable terminal according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

Hereinafter, an apparatus and method for controlling a media player running on a background in a portable terminal will be described in detail.

An operation of a media player running on a background in a portable terminal can be controlled using one of a plurality of keys provided in the portable terminal. The key can be used to perform its inherent operation or control the media player according to a key input method (e.g., a long-press input and a short-press input).

In the following description, the media player includes all kinds of programs that can play media files, such as music files (e.g., MP3 files, WMA files, OGG files, etc) and moving picture files

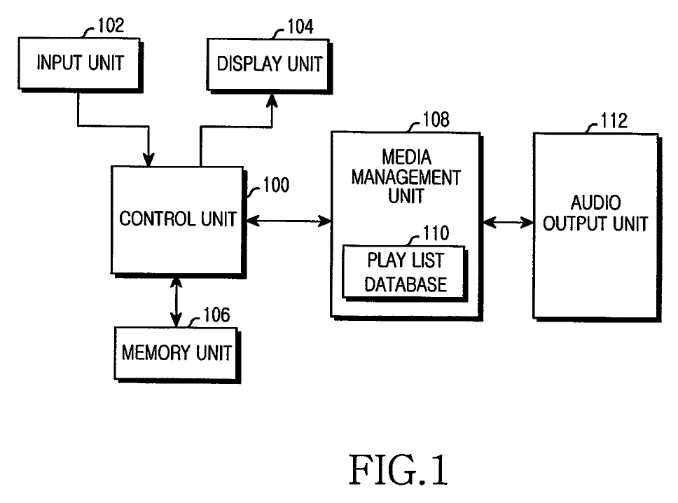

FIG. 1 is a block diagram of an apparatus for controlling a media player running on a background in a portable terminal according to the present invention. The portable terminal includes a mobile communication terminal that can play music files and a media player that can play media files. Examples of the portable terminal are cellular phones, Personal Communication System (PCS) phones, Personal Data Assistants (PDAs), International Mobile Telecommunications-2000 (IMT-2000) terminals, and 4^{th} Generation (4G) broadband systems. The following description will be made with reference to the general structure of the above terminals.

Referring to FIG. 1, the portable terminal includes a control unit 100, an input unit 102, a display unit 104, a memory unit 106, an audio output unit 112, and a media management unit 108. The media management unit 108 includes a play list database 110.

The control unit 100 controls an overall operation of the portable terminal. For example, the control unit 100 processes and controls voice communication and data communication. In addition to the general functions, the control unit 100 sets a key for controlling the media player running on the background. The key can be set using a key provided in the input unit 102. The control unit 100 can detect a key input (e.g., a short-press input and a long-press input) and determine whether the detected key input is a key input for controlling the media player or a key input for performing the inherent operation.

When the key input for controlling the media player is detected while the media player is running on the background, the control unit 100 controls the media management unit 108 to controls the operation of the media player running on the background.

Specifically, when the key input for controlling the media player is detected while the media player is playing the media files on the background, the control unit 100 controls the media management unit 108 to cause the media player to stop playing the media files.

Meanwhile, when the key input for controlling the media player is detected while the media player is not playing media files, the control unit 100 controls the media management unit 108 to search a play list containing media files to be played among the media files stored in the portable terminal and then to cause the media player to play the listed media files according to the play list.

Under the control of the control unit 100, the media management unit 108 controls the play and stop operations of the media player.

In addition, the media management unit 108 searches the play list database 110 and causes the media player to play the media files according to the searched play list.

The play list database 110 stores the play list where the sequence of the media files to be played is set.

The input unit 102 includes a keypad with a plurality of keys to provide key input data (such as a media player control command) corresponding to a user's key input to the control unit 100. In addition, the input unit 102 includes the key for controlling the operation of the media player running on the background.

The display unit 104 displays status information generated during operations, numerals and characters, moving pictures and still pictures, and so on. In addition, the display unit 104 displays screens for the media player and the applications.

The memory unit 106 includes a Read Only Memory (ROM), a Random Access Memory (RAM), and a flash ROM. The memory unit 106 stores a program for controlling the operations of the control unit 100 and the media player management unit 108.

Under the control of the media management unit 108, the audio output unit 112 outputs music played by the media player.

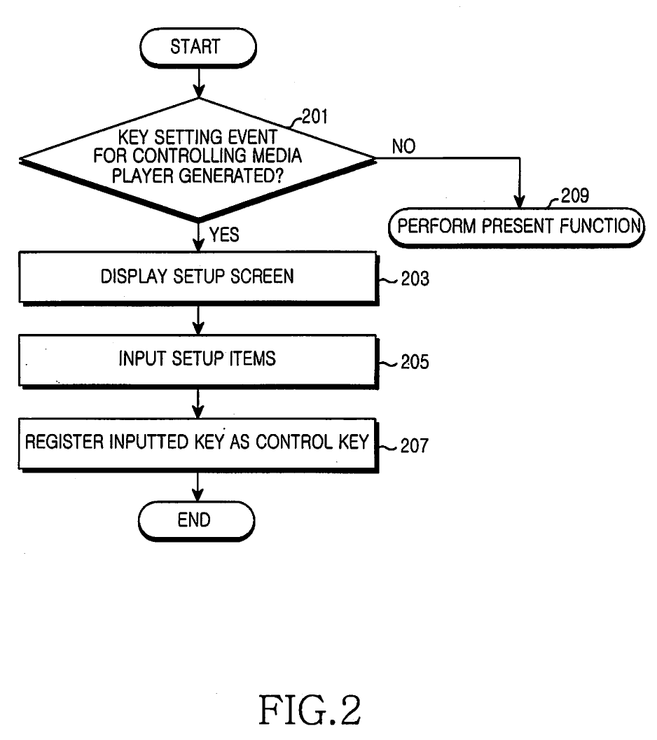

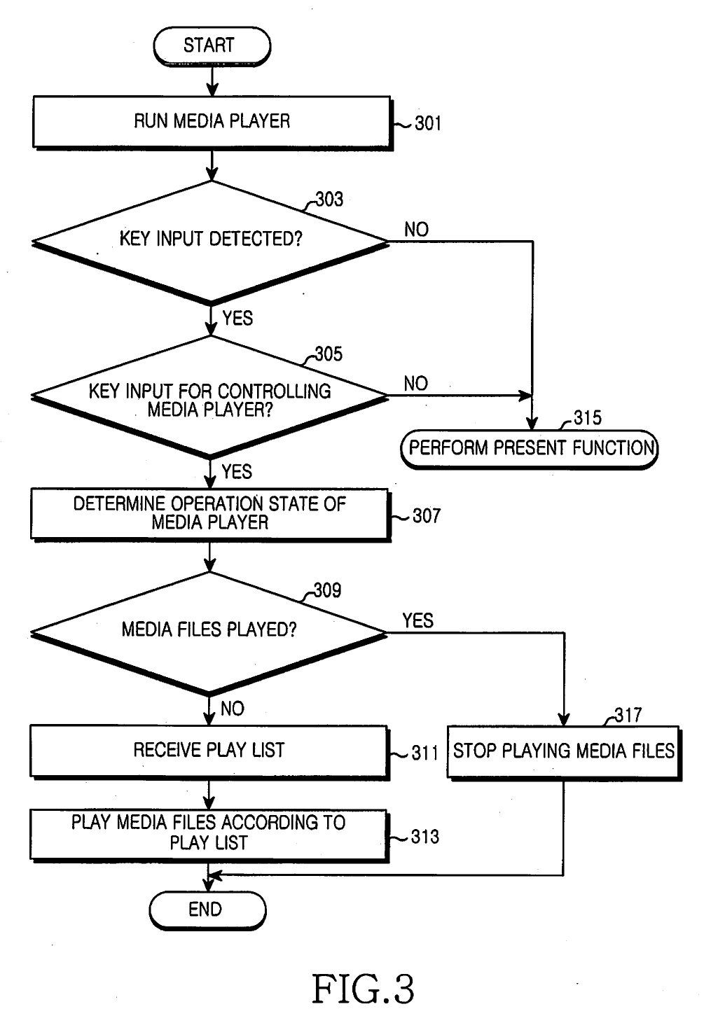

A method for controlling the media player running on the background in the portable terminal of FIG. 1 according to the present invention will be described below in detail. Specifically, a method for setting a key for controlling the media player will be described with reference to the flowchart of FIG. 2, and a method for controlling the media player running on the background using the set key will be described below with reference to the flowchart of FIG. 3.

Referring to FIG. 2, the control unit 100 determines if a key setting event for controlling the media player is generated in step 201. If not, in step 209, the control unit 100 performs a present function (e.g., a standby mode operation) when the event is not generated.

In step 203, the control unit 100 displays a setup screen on the display unit 104 so as to set the key when the event is generated. In step 205, the control unit 100 receives setup items input from a user.

In step 207, the control unit 100 registers the set key using user's key input information. Thereafter, the control unit 100 ends the process.

Referring to FIG. 3, in step 301, the control unit 100 controls the media management unit 108 to run the media player. When an execution of another application is detected while the media player is running, the control unit 100 controls the media player to run on the background. In the following description, it will be assumed that the media player is running on the background.

In step 303, the control unit 100 determines if a user's key input is detected. If not, in step 315, the control unit 100 performs a present function of, for example, maintaining the play operation of the media player when no key input is detected.

In step 305, when the key input is detected, the control unit 100 determines if the detected key input is the key input for controlling the media player.

The control unit 100 can determine if the detected key input is the key input for controlling the media player or other key input for performing the inherent operation of the key according to key input methods. For example, in case where the “*” key is set as the key for controlling the media player, a short-press input of the * key is determined as the key input for performing the inherent operation. On the other hand, a long-press key input of the * key is determined as the key input for controlling the media player.

In step 315, when the detected key input is not the key input for controlling the media player, the control unit 100 performs a present function of, for example, outputting a predetermined key input.

In step 307, when the detected key input is the key input for controlling the media player, the control unit 100 controls the media management unit 108 to detect the current state of the media player. The detection of the current state of the media player means that the control unit 100 controls the media management unit 108 to determine whether the running media player is playing media files or not.

In step 309, the control unit 100 detects if the media player is playing the media files. If not, in step 317, the control unit 100 controls the media management unit 108 to stop the operation of the media player when it is determined that the media player is playing the media files. That is, the control unit 100 controls the media management unit 108 to cause the media player to stop playing the media files without opening the screen of the media player that is playing the media files on the background.

In step 311, the control unit 100 controls the media management unit 108 to obtain a play list when it is determined that the media player is not currently playing media files. Under the control of the control unit 100, the media management unit 108 can obtain the play list by searching the play list database 110.

In step 313, the control unit 100 controls the media management unit 108 to cause the media player to play the media files according to the obtained play list. The media files can be played from the first media file of the play list or from the last media file among media files that have been played by the media player.

Thereafter, the control unit 100 ends the process.

Alternate embodiments of the present invention can also comprise computer readable codes on a computer readable medium. The computer readable medium includes any data storage device that can store data that can be read by a computer system. Examples of a computer readable medium include magnetic storage media (such as ROM, floppy disks, and hard disks, among others), optical recording media (such as CD-ROMs or DVDs), and storage mechanisms such as carrier waves (such as transmission through the Internet). The computer readable medium can also be distributed over network coupled computer systems so that the computer readable code is stored and executed in a distributed fashion. Also, functional programs, codes, and code segments for accomplishing the present invention can be construed by programmers of ordinary skill in the art to which the present invention pertains.

As described above, the portable terminal according to the present invention can control the operations of the media player (e.g., the operations of playing or stopping the media files) using the key for controlling the media player running on the background, without stopping the operations of the running applications, thereby easily controlling the media player.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An apparatus for controlling a media player running on a background in a portable terminal, comprising:
an input unit including a key for controlling the media player;
a media management unit for controlling an operation of the media player running on the background; and
a control unit for controlling the media management unit to control the operation of the media player when the control unit detects an input of the key for controlling the media player and for determining whether the detected key input is a key input for controlling the media player or a key input for performing an inherent operation of the key according to a key input method.

2. The apparatus of claim 1, wherein the media management unit comprises a play list database for storing a play list where sequence of media files to be played is set.

3. The apparatus of claim 2, wherein the media management unit searches the play list database and plays the media files according to the searched play list when it is determined that the media player is not playing media files.

4. The apparatus of claim 3, wherein the media files are played from a last media file played by the media player or from a top of the play list.

5. The apparatus of claim 3, wherein the media management unit controls the media player to stop playing the media files when it is determined that the media player is playing the media files.

6. The apparatus of claim 1, wherein the media player plays the media files including music files and moving picture files.

7. A method for setting a key for controlling a media player running on a background in a portable terminal, comprising the steps of:
displaying a key setup screen when a request for setting a key for controlling the media player is detected; and
detecting a key input and registering the key for controlling the media player.

8. The method of claim 7, wherein the key input is one of a key input for controlling the media player and a key input for performing an inherent operation of the key according to a key input method.

9. The method of claim 7, wherein the media player plays the media files including music files and moving picture files.

10. The method of claim 7, wherein the key for controlling the media player is a key for controlling the media player running on the background.

11. The method of claim 7, further comprising the steps of:
detecting the key input after the media player is run on a background;
determining a current state of the media player when the key input is input; and
stopping an operation of the running media player when it is determined that the media player is playing media files.

12. The method of claim 11, further comprising the steps of:
obtaining a play list of the media player when it is determined that the media player is not playing media files; and
playing the media files according to the obtained play list.

13. The method of claim 12, wherein the media files are played from a last media file played by the media player or from a top of the play list.

14. The method of claim 13, wherein the key input is one of a key input for controlling the media player and a key input for performing an inherent operation of the key according to a key input method.

15. A computer-readable recording medium having recorded thereon a program setting a key for controlling a media player running on a background in a portable terminal, comprising:
a first segment, for displaying a key setup screen when a request for setting a key for controlling the media player is detected; and
a second segment, for detecting a key input and registering the key for controlling the media player.
